(19) United States
(12) Patent Application Publication
(10) Pub. No.: US 2026/0284692 A1
(43) Pub. Date: Sep. 24, 2026

(54) WATER FEATURE WITH LIGHTING AND MISTING CAPABILITIES

(71) Applicant: BELLSON ELECTRIC PTY LTD, Caringbah NSW (AU)

(72) Inventor: David John Sanson, Taren Point NSW (AU)

(21) Appl. No.: 19/570,026

(22) Filed: Mar. 17, 2026

Related U.S. Application Data
(60) Provisional application No. 63/774,540, filed on Mar. 19, 2025.

(51) Int. Cl. B05B 17/08

(52) U.S. Cl. CPC B05B 17/08

(57) ABSTRACT

A water feature apparatus has a water feature and a mount assembly attached to the water feature. At least one annular lighting unit is positioned below the water feature and configured to emit light into a quantity of water in the water feature. A mister is connected to the water feature and configured to supply mist to the water feature along a sidewall of the water feature.

### CROSS REFERENCE TO RELATED APPLICATION

This application claims benefit of U.S. Provisional Application Ser. No. 63/774,540 entitled, “Water Feature with Lighting and Misting Capabilities” filed Mar. 19, 2025, the entire disclosure of which is incorporated herein by reference.

### FIELD OF THE DISCLOSURE

The present disclosure is generally related to water features and more particularly is related to a water feature apparatus with lighting and misting capabilities.

### BACKGROUND OF THE DISCLOSURE

Water features are commonly used to both enhance the appearance of a pool, spa, or similar recreational environment, as well as to make a pool experience more enjoyable for children and adults alike. Similarly, water features which integrate lighting and misting features may add extra ambiance and style to the use of water to enhance the setting. Some pool water features may include a lighting component or misting component, but having both in the same device can be challenging since there is often difficulty in seamlessly combining water feature components with lighting and misting components to provide special visual effects. In part, this is due to the different parameters and needs of each aspect of the water feature, including electrical needs, water supply needs, and electrical or mechanical devices.

Many water features having lighting, such as those used with fountains, often use a lighting device position near the base and angled to shine light on water spraying into the air. However, in this case, a portion of the water remains unlit from the lighting device. Additionally, the illumination of the water feature and the water therein is dependent on ideal weather conditions and pre-positioning the angle of the lighting device relative to the fountain. Similarly, misting features combined with water features often have the lighting devices positioned adjacent to the misting device, resulting in a visible and apparent lighting device. Although such components may be marketed as together, each system is separate and is merely configured to function together.

### SUMMARY OF THE DISCLOSURE

Embodiments of the present disclosure provide a water feature having a mister attachment. Briefly described, in architecture, one embodiment of the system, among others, can be implemented as follows. A mount has a first end and a second end. At least one annular lighting unit is positioned along a length of the mount. At least two stabilizers extend from the second end of the mount away from the first end. An annular cover is configured to interface with the at least two stabilizers. The annular cover is slidable along at least a portion of a length of the at least two stabilizers. The annular cover allows at least a portion of a quantity of light emitted from the at least one annular lighting unit to pass through. A misting device is positionable within an opening of the annular cover. At least a portion of the misting device is positionable interior of the at least two stabilizers.

The present disclosure can also be viewed as providing a water feature apparatus. Briefly described, in architecture, one embodiment of the apparatus, among others, can be implemented as follows. A water feature apparatus has a water feature and a mount assembly attached to the water feature. At least one annular lighting unit is positioned below the water feature and configured to emit light into a quantity of water in the water feature. A mister is connected to the water feature and configured to supply mist to the water feature along a sidewall of the water feature.

The present disclosure can also be viewed as providing a water feature system with lighting and misting capabilities for use with a swimming pool. Briefly described, in architecture, one embodiment of the system, among others, can be implemented as follows. The water feature system with lighting and misting capabilities for use with a swimming pool has a bowl-shaped water feature. A mount assembly is attached to a bottom of the water feature. At least one annular lighting unit is positioned below the water feature and configured to emit light into a quantity of water in the water feature. A mister is positioned in an upper sidewall of the water feature, the mister configured to supply mist to the water feature along the upper sidewall of the water feature and above the quantity of water.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an exploded isometric view illustration of a water feature with lighting and misting capabilities in one example, in accordance with the present disclosure.

FIGS. 2A-2B are detailed exploded isometric view illustrations of the misting attachment and lighting device of FIG. 1, in accordance with the present disclosure.

FIG. 3 is a detailed exploded isometric view illustration of the stabilizers and annular cover of FIG. 1, in accordance with the present disclosure.

FIG. 4 is a cross-sectional view illustration of the water feature with lighting and misting capabilities of FIG. 1 in an extended position, in accordance with the present disclosure.

FIG. 5 is a top view illustration of a water feature with lighting and misting capabilities in another example, in accordance with the present disclosure.

FIG. 6 is a side view illustration of the water feature with lighting and misting capabilities of FIG. 5, in accordance with the present disclosure.

FIG. 7 is an exploded isometric view illustration of the water feature with lighting and misting capabilities of FIG. 5, in accordance with the present disclosure.

FIG. 8 is a top view illustration of a water feature with lighting and misting capabilities in another example, in accordance with the present disclosure.

FIG. 9 is a side view illustration of the water feature with lighting and misting capabilities of FIG. 8, in accordance with the present disclosure.

FIG. 10 is an exploded isometric view illustration of the water feature with lighting and misting capabilities of FIG. 8, in accordance with the present disclosure.

### DETAILED DESCRIPTION

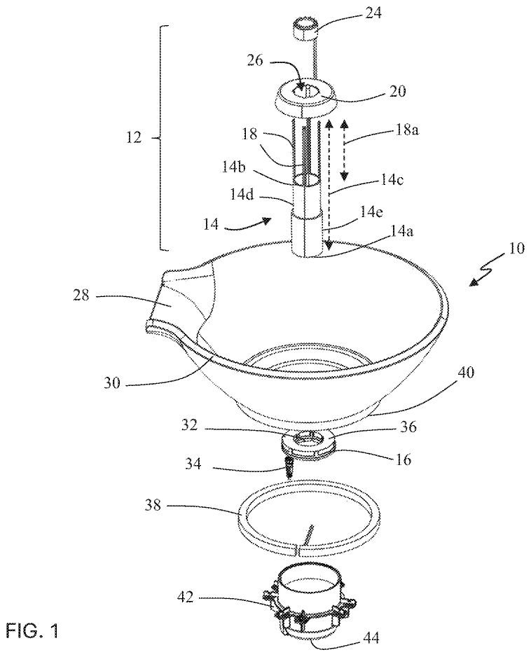

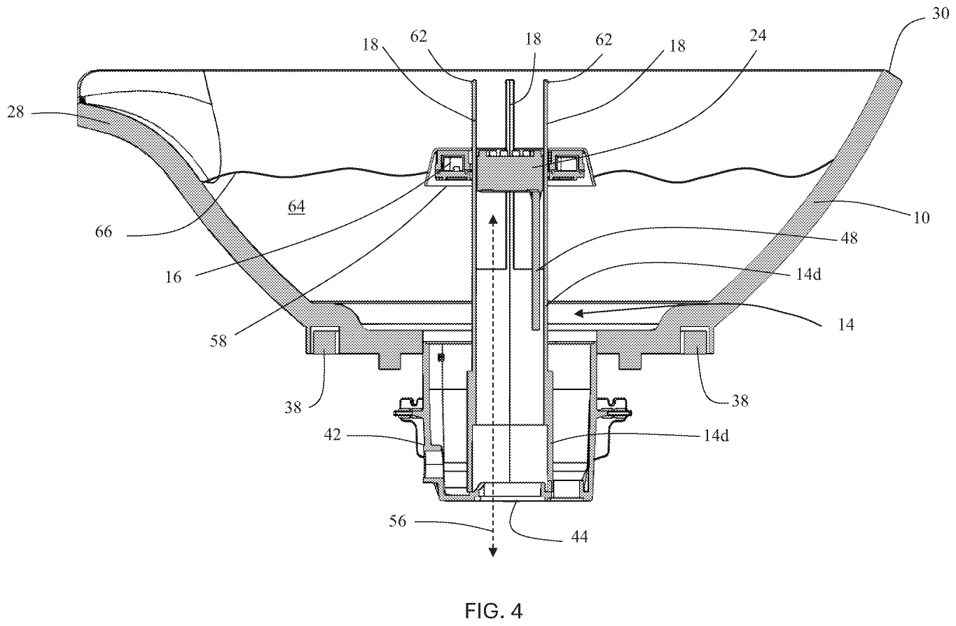

FIG. 1 is an exploded isometric view illustration of a water feature 10 with lighting and misting capabilities in one example, in accordance with the present disclosure. The water feature 10 may include an assembly of components, including a misting attachment 12. The misting attachment 12 has a mount 14 which has a first end 14a and a second end 14b. At least one lighting unit 16, which may be an annular lighting unit 16, may be positioned along a length 14c of the mount 14. It is noted that FIG. 1 illustrates the water feature 10 in exploded view, whereas FIG. 4 illustrates an assembled view with the lighting unit 16 positioned along a length 14c of mount 14. At least two stabilizers 18 extend from the second end 14b of the mount 14 in a direction away from the first end 14a. The stabilizers 18 are any elongated structure that may extend from the second end 14b of the mount 14 in a direction away from the first end 14a. An annular cover 20 may be configured to interface with the at least two stabilizers 18. The annular cover 20 is slidable along at least a portion of a length 18a of the at least two stabilizers 18. The annular cover 20 is further configured to allow at least a portion of a quantity of light emitted from the at least one annular lighting unit 16 to pass through the annular cover 20. A misting device 24 is positionable within an opening 26 of the annular cover 20. At least a portion of the misting device 24 is positionable interior of the at least two stabilizers 18.

The water feature 10 may be any apparatus or structure featuring open water for aesthetic or recreational purposes, including to provide an ambient visual, an auditory, or a tactile effect to individuals near the water feature 10. In some examples, the water feature 10 may be a bowl or other container like structure holding water. The water feature 10 may also have a lip 28 or spillway which is formed to allow water to exit the bowl, thus preventing overflow over the upper rim 30 of the bowl and providing an auditory and visually pleasing effect. The lip 28 may be positioned to rest below the upper rim 30, such that water exits the bowl along a flow path along the lip 28 without reaching the upper rim 30.

The water feature 10 may be formed in various shapes, including a substantially hemispherical shape, a square bowl shape, hexagonal bowl shape, a low polygon bowl shape, or any other shape that is capable of acting as a container or vessel for water as used in water features. The water feature 10 may be made of plastic, metal, a composite material, stone, clay, plaster, concrete, resin, wood, and the like. The water feature 10 may be designed to have a waterproof coating to prevent water seepage or soakage into the material the water feature 10 is made of.

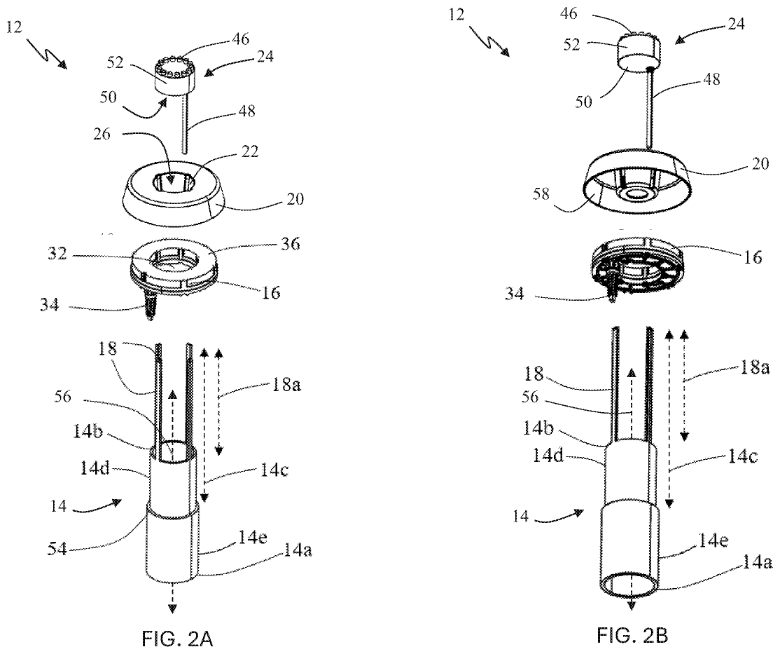

The lighting unit 16 may be an annular lighting unit 16, partially of fully, where the center opening of the annular lighting unit 16 defines a fluid pathway 32. Along this fluid pathway 32, water is able to pass through and enter the water feature 10 and thus the misting device 12. The center opening of the annular lighting unit 16 defining the fluid pathway 32 may be sized and configured such that the lighting unit 16 can freely move up or down along the length 14c of the mount 14. The length of the mount 14 includes at least a portion of the length 18a of the stabilizers 18 plus at least a portion of the length 14c of the mount 14. The portion of the length 14c of the mount 14 which the lighting unit 16 can travel includes the upper mount 14d. The upper mount 14d may have a diameter which is smaller than the diameter of the portion of the mount 14, that is the lower mount 14e. At least a portion of the mount 14 may be cylindrical, however, the mount 14 may be any feasible shape that enables movement of the annular cover 20 along a length 18a of the stabilizers 18 and enables movement of the lighting unit 16 along a length 14c of the mount 14. In some examples, the mount 14 may be a cylindrical shape. Further details and aspects of the lighting unit 16 and misting attachment 12 are discussed relative to FIGS. 2A-2B.

The lighting unit 16 may receive electrical power through a removably connected electrical plug adapter 34 which is positioned offset from the fluid pathway 32, thereby minimizing any water contact with the electrical components of the system. The electrical plug adapter 34 may connect to the lighting unit 16 by threaded fastener, snap on fastener, or other methods that enable both mechanical and electrical connection between the lighting unit 16 and the electrical plug adapter 34. Inside of the lighting unit 16 is at least one light or a lamp. The light or lamp may be any type of light or lamp that may fit within the lighting unit 16. In one example, the light or lamp may be a singular light emitting diode (LED). In another example, the light or lamp may be a plurality of LEDs. The light or lamps within the lighting unit 16 may be positioned such that at least a quantity of light emitted is visible or travels through a top side 36 of the lighting unit 16. The top side 36 of the lighting unit 16 may be made of a material that is transparent or substantially opaque to allow for the transmission of light. The lighting unit 16 itself may be made of any material used in underwater, pool, or water feature applications, such as plastic, metal, glasses, composites, or other materials of the like.

A second lighting unit 38 may also be used to further illuminate the water feature 10, or the water within the water feature 10. The second lighting unit 38 may be positioned on an underside 40 of the water feature 10 to illuminate water contained or accumulated within the water feature 10. This positioning may provide a viewer with the perception that water contained or accumulated within the water feature 10 is itself colored, where the perceived color of the water is the same or substantially the same as the color emitted by the second lighting unit 38. The underside 40 of the water feature 10 may have a region of transparent or opaque material such that at least a quantity of light emitted from the second lighting unit 38 is visible or travels through the underside 40. In the case of a hemispherical water feature 10, this configuration illuminates the concave portion of the water feature 10 and contents contained therein. The second lighting unit 38 may also be annular, partially or fully, to provide even illumination to the water feature 10.

Inside of the second lighting unit 38 is at least one light or a lamp. The light or lamp may be any type of light or lamp that may fit within the second lighting unit 38. In one example, the light or lamp may be a singular LED. In another example, the light or lamp may be a plurality of LEDs, forming an LED strip. The second lighting unit 38 may be flexible or bendable to accommodate fitting into various types of water features 10 with varying shapes and undersides 40.

A mounting assembly 42 may be used to mount the water feature 10 to the ground or other surface near or around a pool, spa, or other ambient setting. The mounting assembly 42 may be integrated into a ground surface, such as concrete, wooden deck, sand, or other surface where water features may be found. The mounting assembly 42 is configured to receive a power supply wire for powering at least one of the misting device 24, the first lighting unit 16, and/or the second lighting unit 38. The mounting assembly 42 is also configured to receive a fluid conduit to connect through a mounting assembly base 44. The entry area for each of the power supply wire and the connection area for a fluid conduit may be separate. That is, the fluid conduit may connect through one opening on the mounting assembly base 44 and the power supply wire may pass through the mounting assembly base 44 through a separate opening. The mounting assembly 42 may be made from a variety of materials, including plastic, epoxy, resin, metal, concrete, clay, and the like.

FIGS. 2A-2B are detailed exploded isometric view illustrations of the misting attachment 12 and lighting device 16, in accordance with the present disclosure. The misting attachment 12 may have a misting device 24 that is any device that mists, atomizes, or ionizes liquid water. In one example, the misting device 24 intakes liquid water and expels it at high pressure through a plurality of nozzles 46 to form a mist. In another example, the misting device 24 may intake liquid water into a heated chamber to vaporize the water and form visible water vapor. In yet another example, the misting device 24 may be an ultrasonic misting device 24 or any other variation of known misting devices 24. In such an example, the misting device 24 itself may be a speaker configured to emit ultrasonic frequencies, where the ultrasonic frequencies cause water vapor formation. The misting device 24 may also be an ionizer.

The misting device 24 is powered by an electrical cable 48 which may be configured to connect to a bottom side 50 of the misting device 24. The electrical cable 48 may connect to the bottom side 50 of the misting device 24 to form a watertight connection, thus preventing water entry into the internal components of the misting device 24 which are not designed for contact with water.

The misting device 24 is configured to be positioned within an opening 26 of the annular cover 20. At least a portion of the misting device 24 is positionable interior of the at least two stabilizers 18. In one example, the missing device 24 may be configured to interface with at least two of the stabilizers 18. In particular, the misting device sidewall 52 may interface or contact at least a portion of the at least two stabilizers 18. The annular cover 20 is designed to receive the stabilizers 18 such that, once the annular cover 20 is positioned on the stabilizers 18, the annular cover 20 can freely move along at least a portion of the length 18a of the stabilizers 18. Accordingly, the misting device 24 is configured to move along at least a portion of the length 18a of the stabilizers 18. Movement of the misting device 24 may be dependent on movement of the annular cover 20. That is, the misting device 24 does not move freely along the length 18a of the stabilizers 18 independent of movement of the annular cover 20 along the length 18a of the stabilizers 18. The stabilizers 18 may be outwardly biased to further secure the stabilizers 18 to the annular cover 20 and to prevent the annular cover 20 from floating above or beyond the terminating end of the stabilizers 18.

At least a portion of the annular cover 20 may be made of a plastic, wood, composite, epoxy, resin, or other positive buoyant material. Construction of the annular cover 20 with a buoyant material enables movement of the annular cover 20 along at least a portion of the length 18a of the stabilizers 18 when water is introduced into the system. For example, if mounted within a container or water feature 10, the introduction of water would cause a buoyant force that overcomes gravity to act upon the annular cover 20 formed from a positive buoyant material. As a result, the annular cover 20 will float to the surface of the water within the closed container or water feature 10. Such movement of the annular cover 20 is enabled by the stabilizers 18. As water is drained or is evaporated from the container or water feature 10, the annular cover 20 will lower at substantially the same rate as the decrease in water level. As the annular cover 20 moves along the length 18a of the stabilizers 18 the misting device 24 follows in such movement as it is carried or positioned within the opening 26 of the misting device 24. In other words, as the annular cover 20 floats along with the increase in the surface level of water, the misting device 24 will also float along with the annular cover 20. Similarly, as water level decreases, the misting device 24 will also move in the same direction and at the same rate as the annular cover 20.

As noted relative to FIG. 1, the mount 14 has a first end 14a and a second end 14b. The stabilizers 18 extend from the mount 14 at the second end 14b. The second end 14b may also have a diameter that is smaller than the diameter of the first end 14a. The mount 14 also is formed of two components, the upper mount 14d and the lower mount 14e. The first end 14a is the terminating end of the lower mount 14e and the second end 14b is the terminating end of the upper mount 14d. A length 14c of the mount 14 is a predetermined length that extends from the terminating end of the stabilizes 18 and until the stop lip 54. The stop lip 54 is a portion of the lower mount 14e where it connects to or mates with the upper mount 14d. The stop lip 54 is a flange-like structure that is the result of the lower mount 14e having a greater diameter than the upper mount 14d.

The stop lip 54 is configured to act as a rest for the lighting unit 16, which has a fluid pathway 32 which serves as an opening for the lighting unit 16 to be positioned along at least a portion of the length 14c of the mount 14. The positioning of the stop lip 54 may limit movement of the lighting unit 16 to along the length 14c of the mount 14, thereby preventing the lighting unit 16 from moving along a length of the lower mount 14e.

The mount 14 also contains a mount fluid pathway 56, which is defined as an opening through the mount 14. In the case of a cylindrical mount 14, the mount fluid pathway 56 travels along a length of the cylindrical mount 14. The mount fluid pathway 56 enables water to pass through the mount 14 and enter into any container or water feature 10 in which the mount 14 is mounted, attached, adhered, connected, or fastened to. For example, if mounted in a container or water feature 10, the mount fluid pathway 56 allows water to enter into the container or water feature 10. As discussed above, as water enters the container or water feature 10, the annular cover 20 and the misting device 24 will have a positive buoyant pressure applied, thus causing the annular cover 20 and the misting device 24 to rise with the increasing or decreasing water level. Additionally, the lighting unit 16 may also experience positive buoyant pressure, thus causing the lighting unit 16 to move along at least a portion of the length of the mount 14c, and therefore at least a portion of the length 18a of the supports 18.

The lighting unit 16 may be positioned below a footprint of the annular cover 20, which additionally has a channel 58. The channel 58 of the annular cover 20 may be sized and configured to receive at least a portion of the lighting unit 16 within, thus creating a three component buoyant system when in the presence of water. For example, as water level increases to the upper mount 14d, the lighting unit 16 may experience a positive buoyant force. Once the water level reaches the stabilizers 18, the annular cover 20 and misting device 24 may then also experience a positive buoyant force.

Several structures and elements illustrated in FIGS. 2A-2B are the same or similar to those shown in FIG. 1 and are not restated herein for brevity in disclosure.

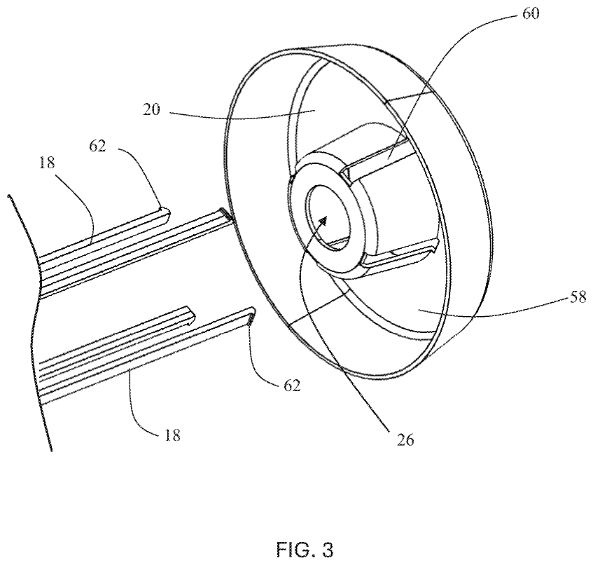

FIG. 3 is a detailed exploded isometric view illustration of the stabilizers 18 and annular cover 20, in accordance with the present disclosure. The annular cover 20 may have slots 60 to receive the stabilizers 18. The stabilizers 18 may pass through the slots 60 such that lateral movement or slippage of the annular cover 20 is limited or restricted. The stabilizers 18 may further be outwardly biased to further secure the stabilizers to the annular cover 20. In this example, installing the annular cover 20 to the stabilizers 18 may require at least one of the arms to be retracted or pulled inwards towards one another. The stabilizers 18 may have a notch 62 positioned on the terminating end of the stabilizers. The notch 62 further secures the stabilizers 18 to the annular cover 20. The notch 62 may be positioned to face outwards so as to not interfere with or hinder positioning of the misting device 24 (not illustrated) within the annular cover 20. The notch 62 may prevent movement of the annular cover 20 beyond the terminating end of the stabilizers 18. For example, if water level rises above the terminating end of the stabilizers 18, the positive buoyant force exerted on the annular cover 20 is negated by the notch 62 securing the annular cover 20. In this example, the annular cover 20, when at rest with the notch 62, will no longer rise with increased water levels.

FIG. 4 is a cross-sectional view illustration of the water feature 10 with lighting and misting capabilities of FIG. 1 in an extended position, in accordance with the present disclosure. FIG. 4 contains several of the same structures and features as described relative to FIGS. 1 and 3, which are not restated herein for brevity in disclosure. In this example, the water feature 10 is partially filled with water 64 having an upper surface 66, and the misting device 24 positioned within the annular cover 20 and the lighting device positioned within the channel 58 of the annular cover 20 are all experiencing a positive buoyant force and are substantially at rest level with the water level.

It should be additionally noted that the misting device 24 electrical cable 48 may travel through the mount fluid pathway 56 and through the mounting assembly 42, exiting through an opening or hole in the mounting assembly base 44. The electrical cable 48 of the misting device 24 may take a different path or route than the electrical connection connected to the electrical plug adapter 34 of the lighting unit 16, as described relative to FIG. 1. The lower mount 14e may connect to an opening on the mounting assembly base 44, where the opening on the mounting assembly base 44 is configured to transport water to the entirety of the system.

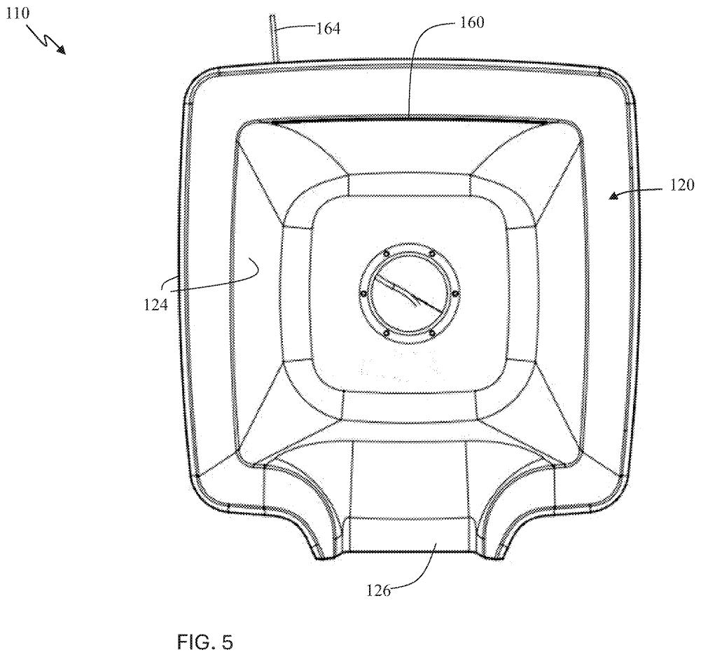

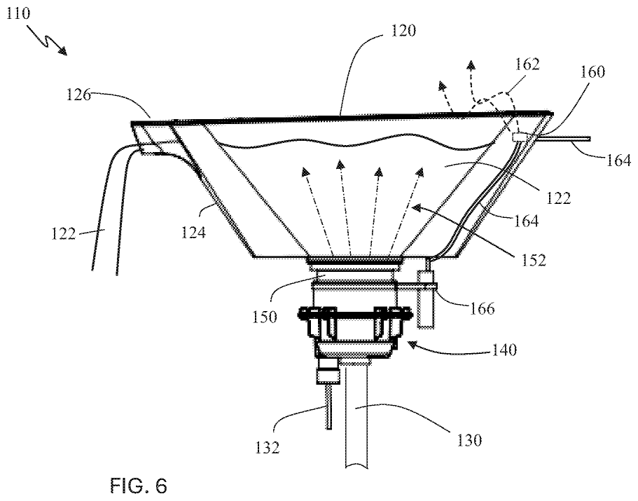

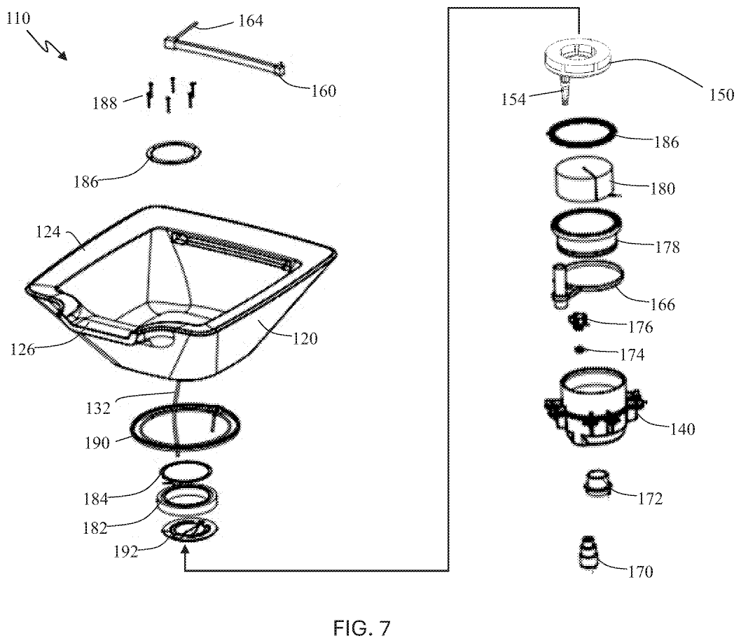

FIGS. 5-10 illustrate another example of the present disclosure. Specifically, FIG. 5 is a top view illustration of a water feature with lighting and misting capabilities 110 in another example, in accordance with the present disclosure. FIG. 6 is a side view illustration of the water feature with lighting and misting capabilities 110 of FIG. 5, in accordance with the present disclosure. FIG. 7 is an exploded isometric view illustration of the water feature with lighting and misting capabilities 110 of FIG. 5, in accordance with the present disclosure. With reference to FIGS. 5-7, the water feature with lighting and misting capabilities 110, which may be referred to herein as the water feature apparatus 110 or the water feature system 110 includes a water feature 120 or water feature structure which may include any type of aesthetic, ambient, functional, or sensory element. In FIGS. 5-7, the water feature 120 is depicted as a water bowl which is sized to hold a quantity of water 122 therein, and where a sidewall 124 of the water feature 120 has a spillway 126 which allows the water 122 to flow from an interior of the water feature 120 to an exterior thereof. Commonly, the water feature 120 may be positioned next to a pool or similar body of water where the water 122 moving through the spillway 126 reconvenes with the pool water.

The water feature 120 may receive a supply of water from the pool water, or from another source, such as from a pump or a separate water supply. The supply of water may be provided through an inlet pipe 130 which may be positioned at least partially below the water feature 120. The inlet pipe 130 may be formed from PVC pipe or a similar material which is capable of transporting water. When the water enters the inlet pipe 130, it may move to and through a mount assembly 140 which is positioned below the water feature 120 and may be secured to the water feature 120. In operation, the mounting assembly 140 may typically be formed within the pool decking in a secure position, such as affixed to concrete or rebar, and the water feature 120 may be attached to the mounting assembly 140 with fasteners or connection devices. The water may move through the mounting assembly 140, and thus be positioned within it, and move to a fluid opening on the bottom of the water feature 120. The water may then at least partially fill the bowl of the water feature 120 from the bottom at a rate selected to provide the desired sensory effect.

The water feature apparatus 110 also includes at least one light or lighting device which may be in the form of at least one annular lighting unit 150 positioned below the water feature 120 and configured to emit light 152 into a quantity of water 122 in the water feature 120. As shown in FIG. 7, the annular lighting unit 150 may include a ring shape with a plurality of lights positioned around the circumference of the ring shape. A bayonet connector 154 may be connected to the annular lighting unit 150 to provide electrical power to it. As shown in FIG. 6, the annular lighting unit 150 may receive electrical power through an electrical supply 132 which is positioned below the mounting assembly 140. The electrical supply may be one or more conductors which may be within a conduit or similar sheathing material which is connected to a bottom end of the mounting assembly 140. The electrical supply 132 may extend through the mounting assembly and connect to the bayonet connector 154 of the annular lighting unit 150 depicted in FIG. 7.

As depicted in FIG. 6, the light 152 maybe emitted upwards from the annular lighting unit 150 and into the bowl of the water feature 120. As such, the light 152 emitted into the water feature 120 may be transmitted through a clear or substantially transparent material along the bottom of water feature 120. For instance, a mounting plate may be used along the bottom of the water feature 120 which has a transparent material therein, such that the light passes through the bottom of the water feature 120. The light 152 may have an effect to illuminate the water within water feature 120, thereby providing a pleasing visual effect. In the example of the annular lining unit 150 is used relative to FIGS. 5-7, it is noted that other lights may be used and they may be positioned in other locations on water features 120. For instance, lights may be positioned within the water feature 120, along a sidewall of the water feature 120, or in another location.

The water feature apparatus 110 further includes a mister 160 which is connected to the water feature 120 and is configured to supply mist to the water feature 120 or in a location proximate to the water feature 120. As shown in FIG. 6, the mister 160 may be positioned along a side wall 124 of the water feature 120, such that it is in a location where it can supply mist 162 to a location above the water 122 or the general vicinity of the water feature 120. The location of mister 160 may be in the upper side wall of the bowl of water feature 120 which may be a location immediately below a rim of the water feature 120. For instance, as shown in FIG. 5, the mister 160 is depicted along the rim edge of water feature 120 in a location where it is effectively tucked under the rim of the water feature 120. In this location, the mister 160 may be partially hidden from sight and protected from environmental elements, such as direct UV rays from the sun.

The mister 160 may be a misting bar, as depicted in FIG. 7 in detail, which may have an elongated length in a shape that substantially matches a contour or shape of the water feature 120. For instance, when the water feature 120 has a square bowl, the mister 160 may include a straight misting bar positioned along a rim of the square bowl. In other examples, the mister 160 may have other shapes, such as those for nozzles or pucks, or similar shapes which are not matched to the contour or shape of the water feature 120.

The mister 160 may receive a supply of water and electrical power to operate. The electrical power may be provided from the electrical supply 132 or another power source, such as a battery, a solar panel, or an external power source. The water supply to the mister 160 may be provided by the water inlet 130 or another water source, such as the water 122 within the bowl itself. The mister 160 may operate using different mechanisms, such as atomizers, thermal processing (condensing or rapid cooling), ultrasonic, piezoelectric, vibratory, pressurized aerosols, or similar techniques which generate mist. As shown in FIG. 6, the electrical supply and/or water supply to mister 160 may be provided through a mister inlet feed 164 which may be located within a sidewall 124 of water feature 120, external to the water feature 120, or in another location relative to the water feature 120.

In one example, the mister inlet feed 164 is positioned through the sidewall 124 of the water feature 120, such as where it extends through a hole or aperture in the sidewall 124. The mister inlet feed 164, in this example, may be secured within the sidewall 124 in a location above the level of the water 122 or in another location where the mister inlet feed 164 interface with the sidewall 124 is waterproof. In another example, the mister inlet feed 164 may be aided by a conduit guide ring 166 which is connectable to an exterior of the mount assembly 140 and can position a conduit interfacing with mister inlet feed 164 in a location below the water feature 120. In this example, the mister inlet feed 164 extends from the mount housing 140, through the conduit guide ring 166, and to the mister 160.

As shown best in FIG. 7, the water feature apparatus 110 may further include additional components. For instance, a conduit adapter 170 for connection to the electrical supply, and a pipe adapted 172 for connecting to the water inlet may be positioned along a bottom of the mounting assembly 140. Hardware such as a cable seal 174 and a niche nut 176 may be used to connect to the mounting assembly 140. The mounting assembly 140 may include an inner housing 178 which is positionable at least partially within the mounting assembly 140 and receives a foam insert 180 therein. The foam insert 180 may be positioned at least partially within the mounting assembly 140, such as within the inner housing 178, such that a supply of water moves through the foam insert 180. The foam insert 180 may act to damper or obstruct the flow of water, such that it gently moves into the water feature 120.

To achieve the desired height and positioning of the apparatus 110, the mounting assembly 140 may operate in conjunction with various height increasing collars 182, and height increasing gaskets 184. These may be optionally used to position the water feature 120 at the desired elevation relative to a pool deck and relative to the depth that the mounting assembly 140 may be positioned. The height increasing collar 182 may be positioned between a top edge of the mounting assembly 140 and a bottom side of the water feature 120. To achieve water-tight seals within the apparatus 110, one or more gaskets 186 may be used, and various fasteners 188 or other hardware may be used to connect the components together. Additionally, depending on the water feature 120, a mounting ring 190 may be used to attach to the bottom of the water feature 120 and secure it in a stationary position relative to the mounting assembly 140. The mounting ring 190 may incorporate supply lines for electrical or water, which may be used by the components of the apparatus 110. In addition, an installation cap 192 may be provided which may cover the bottom hole of the water feature 120 during construction to prevent inadvertent damage to the components, yet be removed during use of the apparatus 110.

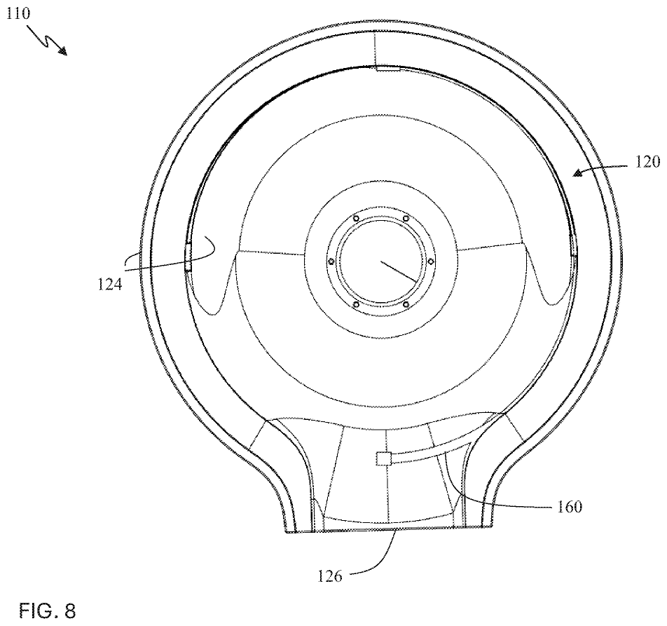

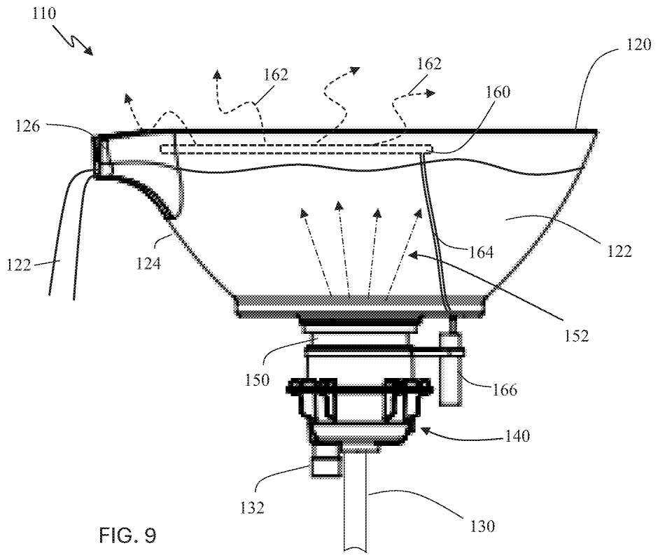

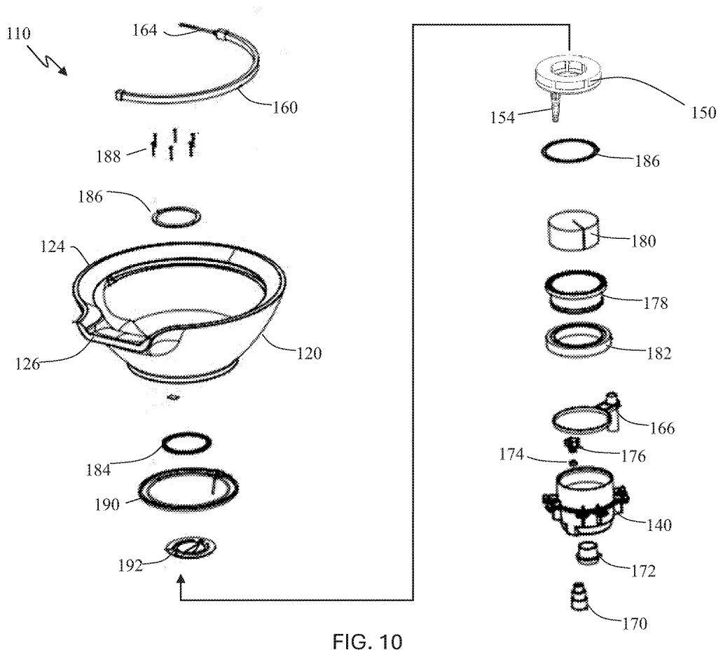

FIGS. 8-10 illustrate another example of the water feature apparatus 110 and water feature system 110. To this end, FIG. 8 is a top view illustration of a water feature 120 with lighting and misting capabilities, FIG. 9 is a side view illustration of the water feature 120 with lighting and misting capabilities of FIG. 8, and FIG. 10 is an exploded isometric view illustration of the water feature with lighting and misting capabilities 110 of FIG. 8, in accordance with the present disclosure. The water feature apparatus 110 of FIGS. 8-10 may include many of the same components as discussed relative to FIGS. 5-7, which are all incorporated by reference and not repeated for brevity in disclosure.

With reference to FIGS. 8-10, the water feature apparatus 110 depicted has a round bowl of the water feature 120 with substantially similar components. For instance, the water feature 120 may be connectable to a mounting assembly 140 with all of the components noted relative to FIG. 7. The mister 160 depicted in FIGS. 8-10 is shaped to fit the round bowl-shaped water feature 120, and thus has a curvature or is shaped as a curved mister or misting bar. This mister 160 may be positioned along the rim of the round bowl of the water feature 120, as shown in detail in the figures. In this position, an end of the mister 160 may extend out in front of the spillway 124, as shown in FIG. 8.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A water feature apparatus, comprising:
a water feature;
a mount assembly attached to the water feature;
at least one annular lighting unit positioned below the water feature and configured to emit light into a quantity of water in the water feature; and
a mister connected to the water feature and configured to supply mist to the water feature along a sidewall of the water feature.

2. The water feature apparatus of claim 1, wherein the water feature is a bowl, and wherein the mister is positioned in an upper sidewall of the bowl.

3. The water feature apparatus of claim 1, further comprising a mister inlet feed, wherein the mister inlet feed is positioned through the sidewall of the water feature.

4. The water feature apparatus of claim 1, further comprising a conduit guide ring connectable to an exterior of the mount assembly.

5. The water feature apparatus of claim 4, wherein a mister inlet feed extends from the mount housing, through the conduit guide ring, and to the mister.

6. The water feature apparatus of claim 1, wherein a water supply and an electric supply are positioned within the mounting assembly.

7. The water feature apparatus of claim 6, further comprising at least one foam insert positioned at least partially within the mounting assembly, wherein the water supply moves through the foam insert.

8. The water feature apparatus of claim 1, further comprising at least one height increasing collar positioned between a top edge of the mounting assembly and a bottom side of the water feature.

9. The water feature apparatus of claim 1, wherein the mister further comprises a misting bar.

10. A water feature system with lighting and misting capabilities for use with a swimming pool, the water feature system comprising:
a bowl-shaped water feature;
a mount assembly attached to a bottom of the water feature;
at least one annular lighting unit positioned below the water feature and configured to emit light into a quantity of water in the water feature; and
a mister positioned in an upper sidewall of the water feature, the mister configured to supply mist to the water feature along the upper sidewall of the water feature and above the quantity of water.

11. The water feature system of claim 10, wherein the bowl-shaped water feature further comprises a round bowl.

12. The water feature system of claim 11, wherein the mister further comprises a curved misting bar positioned along a rim of the round bowl.

13. The water feature system of claim 10, wherein the bowl-shaped water feature further comprises a square bowl.

14. The water feature system of claim 13, wherein the mister further comprises a straight misting bar positioned along a rim of the square bowl.

15. The water feature system of claim 10, further comprising a mister inlet feed, wherein the mister inlet feed is positioned through a sidewall of the water feature.

16. The water feature system of claim 10, further comprising a conduit guide ring connectable to an exterior of the mount assembly.

17. The water feature system of claim 16, wherein a mister inlet feed extends from the mount housing, through the conduit guide ring, and to the mister.

18. The water feature system of claim 10, wherein a water supply and an electric supply are positioned within the mounting assembly.

19. The water feature system of claim 18, further comprising at least one foam insert positioned at least partially within the mounting assembly, wherein the water supply moves through the foam insert.

20. The water feature system of claim 10, further comprising at least one height increasing collar positioned between a top edge of the mounting assembly and a bottom side of the water feature.
